(19) United States
(12) Patent Application Publication
(10) Pub. No.: US 2026/0242296 A1
(43) Pub. Date: Aug. 20, 2026

(54) COMPOSITION OF FLEXIBLE CERAMIC NANOFIBERS FOR THERMAL INSULATION APPLICATIONS AND METHOD THEREOF

(71) Applicant: Jazze Marie Gorman, Houston, TX (US)

(72) Inventor: Jazze Marie Gorman, Houston, TX (US)

(21) Appl. No.: 19/217,403

(22) Filed: May 23, 2025

Related U.S. Application Data
(63) Continuation-in-part of application No. 19/056,905, filed on Feb. 19, 2025.

(51) Int. Cl. C04B 35/622; C04B 35/64; C04B 38/04

(52) U.S. Cl. CPC C04B 35/62259; C04B 35/64; C04B 38/04; C04B 2235/5212; C04B 2235/5232; C04B 2235/95; C04B 2235/9607

(57) ABSTRACT

The present disclosure relates to a method (200) for preparing flexible ceramic nanofibers for thermal insulation applications, comprising preparing a titanium precursor solution by dissolving tetra butyl titanate (TBOT) in anhydrous methanol. The method (200) comprising adding glacial acetic acid in a particular ratio to tetra butyl titanate (TBOT) while stirring. The method (200) comprising adding acetylacetone in a particular ratio to tetra butyl titanate (TBOT) and stirring vigorously. The method (200) comprising preparing a silica precursor solution by dissolving tetraethyl orthosilicate (TEOS) in anhydrous methanol in a particular ratio. The method (200) comprising adding polyethylene oxide (PEO) and heating mixture. The method (200) comprising mixing the titanium precursor solution and silica precursor solutions and constantly stirring to form a TiO₂/SiO₂ electrospinning precursor solution. The method (200) comprising electrospinning the precursor solution to form nanofibrous membranes under the pre-determined conditions. The method (200) comprising sintering the nanofibrous membranes to obtain porous ceramic nanofiber membranes.

### FIELD OF THE INVENTION

Embodiments of the present invention relate to the field of thermal insulation and specifically relates to a composition and method for preparation of flexible ceramic nanofibers.

### DESCRIPTION OF THE RELATED ART

Thermal insulation material are used in a variety of applications, as they provide strength and pliability, for a broad spectrum of thermal insulation needs across various sectors. Traditionally, thermal insulation products that tend to be stiff or fragile, leading to inadaptability and poor installation efficiency, particularly in environments that require complex coverage or customized solutions, such as industrial equipment with irregular contours, retrofitted residential buildings, or specialized commercial systems. In addition to the lack physical flexibility in existing thermal insulation material is most notable during handling and deployment, significantly increasing the likelihood of damage during transport or installation, which translates to higher maintenance and replacement costs, and increased inconvenience for end users.

One of the most compelling needs in this sector, is use of ultralightweight material and flexible material for thermal insulation. As the desired lightweight profile is particularly advantageous for modern industrial and logistic practices, where minimizing load and optimizing labour efficiency are critical. Addressing of various logistical challenges associated with many of the existing thermal insulation materials, especially in projects with strict weight constraints or hard-to-reach installation sites, is need of the hour. Thus, there is need for a practical solution that aligns with current trends favouring mobility, ease of handling, and rapid deployment, particularly in aerospace, automotive, or modular building applications. Moreover, there is need of insulation material that maintains exceptional performance even under extreme thermal, environmental, or mechanical conditions, and have potential for critical applications such as energy plants, transportation systems, and heavy machinery, where insulation failure can result in costly downtime or hazardous scenarios.

In addition to this, the currently used method for producing effective thermal insulation material is riddled with operational challenges and environmental concerns. Thereby, there is need for developing a highly consistent and repeatable method of production, which is essential for large-scale industrial operations. There is need for a production method which is robust in nature and eliminates the need for the frequent maintenance and premature replacement cycles, often required in conventional practices.

Furthermore, there is a need to develop a thermal insultation material and production method, which is environmentally responsible and sustainable. The need for a sustainable approach not only conserves natural resources but also helps meet evolving environmental regulations and carbon footprint reduction goals, which is particularly attractive for green building initiatives and sustainable infrastructure projects along with being cost effective in long run.

Therefore, there is a critical need for a composition and method for preparation of flexible ceramic nanofibers for thermal insulation applications.

### SUMMARY OF THE INVENTION

Embodiments of the present invention relate to a composition of flexible ceramic nanofibers for thermal insulation applications. The composition comprising tetraethyl orthosilicate (TEOS) as a silica precursor. The composition also comprising tetra butyl titanate (TBOT) as a titanium precursor. The composition also comprising polyethylene oxide (PEO) as a porogen. The composition also comprising glacial acetic acid as a catalyst for hydrolysis and condensation reactions. The composition also comprising acetylacetone as a chelating agent for precursor stabilization.

In accordance with an embodiment of the present invention, the composition comprising a 208.33 Mw of tetraethyl orthosilicate (TEOS).

In accordance with an embodiment of the present invention, the composition also comprising a 340.32 Mw of tetra butyl titanate (TBOT).

In accordance with an embodiment of the present invention, the composition also comprising a 1,000,000 Mw of polyethylene oxide (PEO).

In accordance with an embodiment of the present invention, the composition also comprising a 60 Mw of glacial acetic acid.

In accordance with an embodiment of the present invention, the composition also comprising a 100 Mw of acetylacetone.

In accordance with an embodiment of the present invention, the composition also comprises anhydrous methanol (CH3OH).

In accordance with an embodiment of the present invention, the composition also comprises a 32 Mw of anhydrous methanol (CH3OH).

In accordance with an embodiment of the present invention, the composition also comprises deionized water.

In accordance with an embodiment of the present invention, the composition also comprises an 18 Mw of deionized water.

Another embodiment of the present invention relates to a method for preparation of flexible ceramic nanofibers for thermal insulation applications. The method comprising preparing a titanium precursor solution by dissolving tetra butyl titanate (TBOT) in anhydrous methanol. The method also comprising adding glacial acetic acid in a particular ratio to tetra butyl titanate (TBOT) while stirring. The method also comprising adding acetylacetone in a particular ratio to tetra butyl titanate (TBOT) and stirring vigorously. The method also comprising preparing a silica precursor solution by dissolving tetraethyl orthosilicate (TEOS) in anhydrous methanol in a particular ratio. The method also comprising adding polyethylene oxide (PEO) and heating mixture. The method also comprising mixing the titanium precursor SOLUTION and silica precursor solutions and constantly stirring to form a TiO₂/SiO₂ electrospinning precursor solution. The method also comprising electrospinning the precursor solution to form nanofibrous membranes under the pre-determined conditions. The method also comprising sintering the nanofibrous membranes to obtain porous ceramic nanofiber membranes.

In accordance with an embodiment of the present invention, the glacial acetic acid is added in a molar ratio of 3:1 to tetra butyl titanate (TBOT).

In accordance with an embodiment of the present invention, the acetylacetone is added in a 1:1 molar ratio to tetra butyl titanate (TBOT).

In accordance with an embodiment of the present invention, the tetraethyl orthosilicate (TEOS) is dissolved in anhydrous methanol in a molar ratio of 0.2 relative to tetra butyl titanate (TBOT).

In accordance with an embodiment of the present invention, a 3% v/v of glacial acetic acid is added to the tetraethyl orthosilicate (TEOS) dissolved in anhydrous methanol.

In accordance with an embodiment of the present invention, the polyethylene oxide (PEO) at 1% w/v concentration is added to tetraethyl orthosilicate (TEOS).

In accordance with an embodiment of the present invention, the TiO₂/SiO₂ electrospinning precursor solution have viscosity between 500 and 2000 cp.

In accordance with an embodiment of the present invention, the process of sintering further includes heating to 600° C. at a rate of 1° C./min.

In accordance with an embodiment of the present invention, the process of sintering further includes maintaining the membranes at 600° C. for 2 hours.

In accordance with an embodiment of the present invention, the process of sintering further includes cooling to room temperature to obtain porous ceramic nanofiber membranes.

In accordance with an embodiment of the present invention, the electrospinning of the precursor solution is performed at ambient temperature of approximately 25° C.

In accordance with an embodiment of the present invention, the electrospinning of the precursor solution is performed at relative humidity of 45%-55%.

In accordance with an embodiment of the present invention, the electrospinning of the precursor solution is performed at spinning voltage of 15 kV.

In accordance with an embodiment of the present invention, the electrospinning of the precursor solution is performed using needle gauge of 25G and syringe advancement rate of 2 mL/h, with a 20 cm distance between needle and collector.

In accordance with an embodiment of the present invention, the electro-spined precursor solution is collected by a roller receiver.

In accordance with an embodiment of the present invention, the method also includes performing calcination to decompose polyethylene oxide (PEO) in the final ceramic structure.

### BRIEF DESCRIPTION OF THE DRAWINGS

So that the manner in which the above-recited features of the present invention is understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

The invention herein will be better understood from the following description with reference to the drawings, in which:

FIG. 1 illustrates a block diagram of a composition of flexible ceramic nanofibers for thermal insulation applications, in accordance with an embodiment of the present invention; and

FIG. 2 illustrates a flowchart of a method for preparation of flexible ceramic nanofibers for thermal insulation applications, in accordance with an embodiment of the present invention.

It should be noted that the accompanying figure is intended to present illustrations of exemplary embodiments of the present disclosure. This figure is not intended to limit the scope of the present disclosure. It should also be noted that the accompanying figure is not necessarily drawn to scale.

### DETAILED DESCRIPTION OF THE INVENTION

In the following detailed description, numerous specific details are set forth in order to provide a thorough understanding of the embodiment of the invention as illustrative or exemplary embodiments of the invention, specific embodiments in which the invention may be practiced are described in sufficient detail to enable those skilled in the art to practice the disclosed embodiments. However, it will be obvious to a person skilled in the art that the embodiments of the invention may be practiced with or without these specific details. In other instances, well-known methods, procedures and components have not been described in detail so as not to unnecessarily obscure aspects of the embodiments of the invention.

The following detailed description is, therefore, not to be taken in a limiting sense, and the scope of the present invention is defined by the appended claims and equivalents thereof. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. References within the specification to “one embodiment,” “an embodiment,” “embodiments,” or “one or more embodiments” are intended to indicate that a particular feature, structure, or characteristic described in connection with the embodiment is included in at least one embodiment of the present invention.

Although the terms first, second, etc. may be used herein to describe various elements, these elements should not be limited by these terms. These terms are generally only used to distinguish one element from another and do not denote any order, ranking, quantity, or importance, but rather are used to distinguish one element from another. Further, the terms “a” and “an” herein do not denote a limitation of quantity, but rather denote the presence of at least one of the referenced items.

The conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

### The Following Brief Definition of Terms Shall Apply Throughout the Present Invention

The terms “determining”, “measuring”, “evaluating”, “assessing,” “assaying,” and “analyzing” can be used interchangeably herein to refer to any form of measurement, and include determining if an element is present or not. (e.g., detection). These terms can include both quantitative and/or qualitative determinations. Assessing may be relative or absolute.

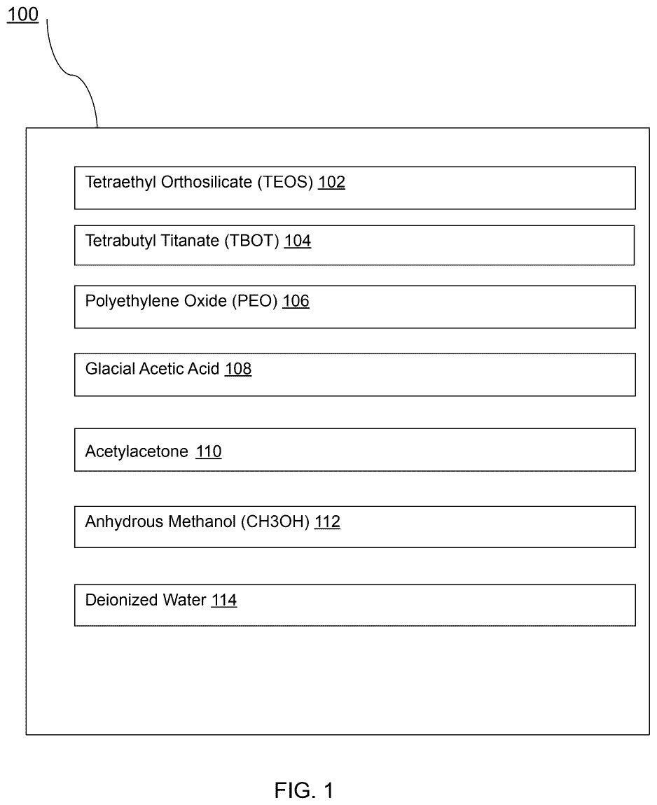

FIG. 1 illustrates a flowchart of a composition 100 for preparing flexible ceramic nanofibers for thermal insulation applications, in accordance with an embodiment of the present invention.

The composition 100 may be comprising tetraethyl orthosilicate (TEOS) 102 as a silica precursor. The composition 100 may be comprising tetra butyl titanate (TBOT) 104 as a titanium precursor. The composition 100 may be comprising polyethylene oxide 106 (PEO) as a porogen. The composition 100 may be comprising glacial acetic acid 108 as a catalyst for hydrolysis and condensation reactions. The composition 100 may be comprising acetylacetone 110 as a chelating agent for precursor stabilization.

The composition 100 may be comprising a 208.33 Mw of tetraethyl orthosilicate (TEOS) 102. The composition 100 may be comprising a 340.32 Mw of tetra butyl titanate (TBOT) 104. The composition 100 may be comprising a 1,000,000 Mw of polyethylene oxide (PEO) 106. The composition 100 may be comprising a 60 Mw of glacial acetic acid 108. The composition 100 may be comprising a 100 Mw of acetylacetone 110.

The composition 100 may also comprise anhydrous methanol (CH3OH) 112.

The composition 100 may also comprise a 32 Mw of anhydrous methanol (CH3OH) 112.

The composition 100 may also comprise deionized water 114.

The composition 100 may also comprise an 18 Mw of deionized water 114.

In a preferred embodiment, the preparation of the composition may require various equipment including, but not limited to, Round bottom flask, Magnetic stirrer and stir bar, Heating mantle or hot plate, Condenser (if using a solvent), Thermometer, Vacuum filtration setup, and Fume hood (for safety). The following table 1 provides material for precursor preparation.

TABLE 1
Material for Precursor Preparation

| Preparation of | | | | |
|---|---|---|---|---|
| the precursor | | | | Density |
| Regent | CAS # | Concentration | Mw | (g/ml) |
| Tetraethyl | 78-10-4 | ≥98.0% | 208.33 | — |
| orthosilicate | | | | |
| (TEOS) 102 | | | | |
| Tetrabutyl titanate | 5593-70-4 | ≥99.0% | 340.32 | 1 |
| (TBOT) 104 | | | | |
| Glacial acetic acid | 64-19-7 | ≥99.5% | 60 | 1.05 |
| (HAc) 108 | | | | |
| Anhydrous | 67-56-1 | ≥99.5% | 32 | 0.792 |
| methanol | | | | |
| (CH3OH) 112 | | | | |
| Acetylacetone | 123-54-6 | ≥98.0% | 100 | 0.98 |
| (Hacac) 110 | | | | |
| Polyethylene oxide | 25322-68- | Mw~1000,000 | 1,000,000 | — |
| (PEO) 106 | 3 | | | |
| Deionized water | 7732-18-5 | | 18 | 1 |
| 114 | | | | |

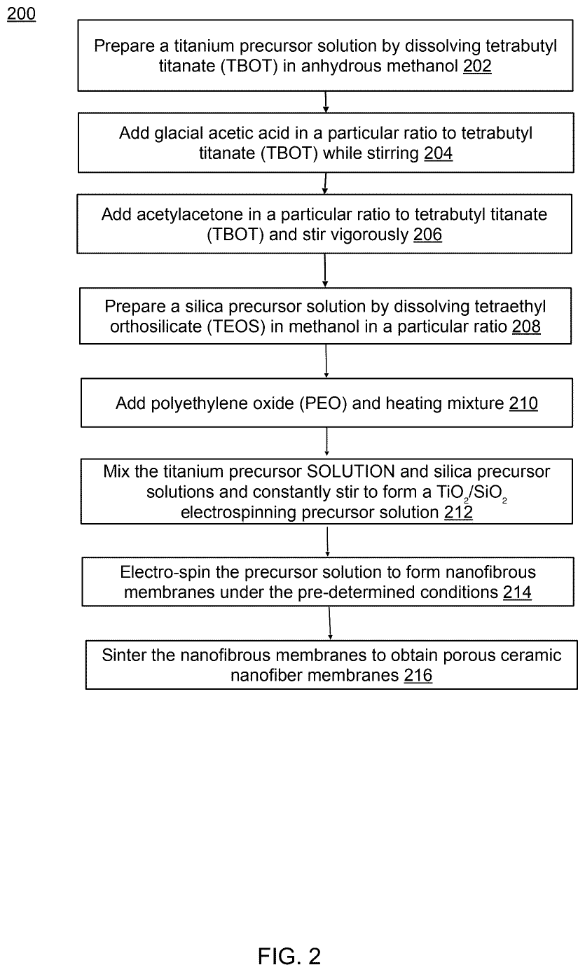

FIG. 2 illustrates a flowchart of a method 200 for preparing flexible ceramic nanofibers for thermal insulation applications, in accordance with an embodiment of the present invention.

The method 200 may be comprising the following steps.

At 202, preparing a titanium precursor solution by dissolving tetra butyl titanate (TBOT) 104 in anhydrous methanol 112.

At 204, adding glacial acetic acid 108 in a particular ratio to tetra butyl titanate (TBOT) 104 while stirring.

At 206, adding acetylacetone 110 in a particular ratio to tetra butyl titanate (TBOT) 104 and stirring vigorously.

At 208, preparing a silica precursor solution by dissolving tetraethyl orthosilicate (TEOS) 102 in anhydrous methanol 112 in a particular ratio.

At 210, adding polyethylene oxide (PEO) 106 and heating mixture.

At 212, mixing the titanium precursor solution and silica precursor solutions and constantly stirring to form a TiO₂/SiO₂ electrospinning precursor solution.

At 214, electrospinning the precursor solution to form nanofibrous membranes under the pre-determined conditions.

At 216, sintering the nanofibrous membranes to obtain porous ceramic nanofiber membranes.

The glacial acetic acid 108 may be added in a molar ratio of 3:1 to tetra butyl titanate (TBOT) 104.

The acetylacetone 110 may be added in a 1:1 molar ratio to tetra butyl titanate (TBOT) 104.

The tetraethyl orthosilicate (TEOS) 102 may be dissolved in anhydrous methanol 112 in a molar ratio of 0.2 relative to tetra butyl titanate (TBOT) 104.

The 3% v/v of glacial acetic acid 108 may be added to the tetraethyl orthosilicate (TEOS) dissolved in anhydrous methanol 112.

The polyethylene oxide (PEO) 106 at 1% w/v concentration may be added to tetraethyl orthosilicate (TEOS) 102.

The TiO₂/SiO₂ electrospinning precursor solution may have viscosity between 500 and 2000 cp.

The process of sintering may further include heating to 600° C. at a rate of 1° C./min. The process of sintering may further include maintaining the membranes at 600° C. for 2 hours. The process of sintering may further include cooling to room temperature to obtain porous ceramic nanofiber membranes.

The electrospinning of the precursor solution may be performed at ambient temperature of approximately 25° C.

The electrospinning of the precursor solution may be performed at relative humidity of 45%-55%.

The electrospinning of the precursor solution may be performed at spinning voltage of 15 kV.

The electrospinning of the precursor solution may be performed using needle gauge of 25G and syringe advancement rate of 2 mL/h, with a 20 cm distance between needle and collector.

The electro-spined precursor solution may be collected by a roller receiver.

The method 200 may also include performing calcination to decompose polyethylene oxide (PEO) 106 in the final ceramic structure.

In a preferred embodiment, for preparation of the titanium precursor, in a fume hood, the desired amount of tetra butyl titanate (TBOT) 104 may be weighed and added to a round bottom flask. Followed by, adding anhydrous methanol 112 in a volume equivalent to twice the TBOT to help dilute the tetra butyl titanate (TBOT) 104 and keep the reaction free of moisture. Followed by, placing the flask in an ice bath to keep the exothermic reaction under control. Followed by, adding glacial acetic acid 108 in a molar ratio of 3:1 to tetra butyl titanate (TBOT) 104 dropwise to the flask while maintaining agitation using a magnetic stirrer, with ideal temperature between 20 and 30° C. to avoid the formation of byproducts and the reaction getting out of control. Followed by, keeping the mixture under stirring at room temperature for 12 hours. As the reaction progresses, the viscosity may increase and the solution may turn pale yellow. Followed by, adding acetylacetone 110 (1:1 molar to tetra butyl titanate (TBOT) 104) dropwise to the solution under vigorous stirring for 2 hours until a reddish-gold color may be obtained.

In a preferred embodiment, for silica precursor preparation, in a separate container containing a pre-determined volume of anhydrous methanol 112, which may be equivalent to that used with the titanium precursor and add a quantity of tetraorthosilane (TEOS) 102 equivalent to 20% molar of TBOT 104. The anhydrous methanol 112 may act as a solvent and participates in transesterification, replacing ethoxy groups (—OEt) of TEOS 102 with methoxy (—OCH₃). Followed by, adding 3% v/v of glacial acetic acid 108 to catalyze hydrolysis by protonating ethoxy groups, facilitating substitution by —OH groups. The hydrolysis may continue to form silanol (Si—OH), a precursor of silica. Followed by, adding 1% w/v of polyethylene oxide (PEO) 106. Heat the mixture below 50° C. to promote complete dilution of the polymer and mix until a homogeneous solution of SiO₂ precursor is obtained. The silanol group may polymerize to create a silica network. The PEO 106 may act as a tempering agent or porogen, forming an intertwined polymer network.

In a preferred embodiment, for preparing precursor mixture, dilute the titanium precursor previously obtained with anhydrous methanol 112 in a quantity equivalent to its weight and mix well until a homogeneous solution is obtained. Followed by adding the Silica precursor slowly to the Titanium precursor, keeping the stirring constant until a homogeneous solution is formed. The ideal viscosity for electrospinning may be between 500 and 2000 cp. Dilute the resulting solution with anhydrous methanol 112, if it is very viscous or evaporate at low temperature (50° C.) if it's very dilute.

In an embodiment of the present disclosure, the precursor nanofibrous membranes may be heated up to a pre-determined temperature at a suitable heating rate. The membranes may then be held for a pre-determined period at that temperature range and naturally cooled to room temperature; the TiO₂/SiO₂ nanofibrous membranes may be obtained.

In some embodiment of the present disclosure, the composition 100 may comprise a titanium-containing precursor comprising reactive functional groups, including terminal alkenes, present in a molar ratio of 50-70% relative to the total precursor solution, facilitating further radical polymerization and segment integration. The composition 100 may include a silicon-containing precursor comprising hydrolysable alkoxy groups, contributing to enhanced thermal resistance and flexibility. The composition 100 may also include a polymeric binder selected from polyethylene oxide, providing spinnability and structural uniformity during electrospinning. The composition 100 may also include a solvent system comprising alcohol-based solvents and glacial acetic acid 108, promoting solubility and homogeneity of the components, wherein upon processing through electrospinning and subsequent heat treatment, produces nanofibrous membranes with low thermal conductivity, high tensile strength, and adaptability for thermal insulation applications in aerospace, electronics, and flexible insulation fields.

In some embodiment of the present disclosure, the titanium-containing precursor may constitute 30-40% by weight of the total composition, ensuring optimal thermal stability and mechanical performance. The silicon-containing precursor may constitute 15-20% by weight of the total composition, enhancing structural flexibility and insulation properties. The polymeric binder may comprise polyethylene oxide, present in an amount of 0.5-1.5% by weight, ensuring uniform fiber formation during electrospinning. The solvent system, including anhydrous methanol 112 and glacial acetic acid 108, may constitute 40-50% by weight of the total composition, facilitating dissolution and homogenization of the precursors. The titanium-containing precursor may be synthesized through a reaction involving tetra butyl titanate (TBOT) 104, glacial acetic acid 108, and acetylacetone 110 in a molar ratio of 1:3:1, contributing to the formation of polydiacetictitanium (PDET) as a source of titanium. The titanium-containing and silicon-containing precursors may be combined in a molar ratio of 3:1, balancing thermal insulation and flexibility in the resulting nanofibrous membranes.

In some embodiments, the polymeric binder may comprise polyethylene oxide (PEO) 106 with a molecular weight of approximately 1,000,000, facilitating spinnability and uniform distribution of nanofibers. The titanium-containing precursor may be concentrated and re-dissolved in anhydrous methanol 112 to form a golden-red solution prior to incorporation into the composition. The nanofibrous membranes may exhibit thermal conductivity of no more than 0.032 W/m, at room temperature, ensuring effective insulation. The nanofibrous membranes may demonstrate a tensile strength of at least 4 MPa after heat treatment, enabling reliable performance in insulation applications. The solvent system may include a mixture of anhydrous methanol 112 and glacial acetic acid 108 in a volume ratio of 4:1, optimizing solubility and preventing premature gelation. The heat treatment process may involve heating the precursor nanofibers to 700° C. at a rate of 5° C./min and holding for 2 hours, forming thermally stable nanofibrous membranes.

in some embodiments, the method 200 may comprise synthesizing a titanium-containing precursor through a reaction involving a titanium source, an organic acid, and a chelating agent, wherein the reaction is conducted under controlled conditions to ensure the formation of a precursor with reactive functional groups, including terminal alkenes, present in a molar ratio of 50-70%. The method 200 may include dissolving the titanium-containing precursor in an alcohol-based solvent system comprising anhydrous methanol 112 and glacial acetic acid 108 to create a homogenous solution. The method 200 may also include introducing a silicon-containing precursor with hydrolysable alkoxy groups into the solution to enhance flexibility and thermal resistance. The method 200 may also include incorporating a polymeric binder selected from polyethylene oxide 106 to provide spinnability and structural uniformity during electrospinning. The method 200 may also include electrospinning the prepared solution under controlled environmental parameters, including a spinning voltage, needle-to-collector distance, and advancing syringe speed, to produce precursor nanofibers. The method 200 may also include subjecting the precursor nanofibers to a heat treatment process, wherein the nanofibers are heated to a temperature range of 600-700° C. at a controlled heating rate, facilitating the removal of organic components and the formation of thermally stable ceramic nanofibrous membranes.

In some embodiments, the titanium-containing precursor may be aged after synthesis to enhance gel network strength, improving the stability of the nanofibers during the electrospinning and heat treatment processes. The electrospinning process may be performed using a stainless-steel needle of gauge 25, a spinning voltage of 15 kV, and a syringe advancement speed of 2 mL/h to achieve consistent nanofiber morphology. The environmental parameters for electrospinning may be controlled to maintain a relative humidity of 45-55% and a temperature of 25° C., minimizing fiber defects and enhancing uniformity. The nanofibers may be collected on a rotating drum during electrospinning to align the fibers and improve the mechanical properties of the resulting membranes. The heat treatment process may include a cooling phase after reaching 700° C., allowing the nanofibers to naturally cool to room temperature to prevent thermal shock and ensure structural integrity.

In some embodiments, the composition 100 for preparing flexible ceramic nanofibers for thermal insulation applications may be developed by combining specifically selected materials and processes to ensure superior thermal and mechanical performance. The composition 100 may comprise a titanium-containing precursor, a silicon-containing precursor, a polymeric binder, and a solvent system, each contributing specific functional roles. The titanium-containing precursor may contain reactive functional groups, including terminal alkenes, present in a molar ratio of 50 to 70 percent relative to the total precursor solution. This molar ratio may ensure optimal reactivity for radical polymerization, enabling efficient integration of additional segments during processing. The silicon-containing precursor, with hydrolysable alkoxy groups, may enhance the thermal resistance and flexibility of the nanofibers, ensuring their adaptability for high-temperature applications.

In some embodiments, the titanium-containing precursor is synthesized through a reaction involving tetra butyl titanate 104, glacial acetic acid 108, and acetylacetone 110, conducted under controlled conditions. This reaction may produce polydiacetictitanium, which acts as a source of titanium for the composition 100. The synthesized gel may undergo an aging process to strengthen the gel network and improve stability during subsequent processing stages. The gel may then dissolved in a solvent system comprising anhydrous methanol 112 and glacial acetic acid 108 to create a uniform and homogeneous solution. The silicon-containing precursor may be introduced into this solution to enhance the compatibility and interaction between components, resulting in a robust hybrid mixture.

The polymeric binder may be selected for this composition 100 is polyethylene oxide, which ensures spinnability and structural uniformity during the electrospinning process. Polyethylene oxide may be incorporated in an amount ranging from 0.5 to 1.5 percent by weight of the total composition, facilitating the formation of uniform nanofibers. The solvent system, comprising methanol and glacial acetic acid in a ratio of 4:1, promotes solubility and homogenization of the precursors while preventing premature gelation. This carefully designed combination of materials and conditions may ensure the production of high-quality nanofibrous membranes with consistent properties.

In some embodiments, the electrospinning process may be carried out under specific environmental and operational parameters to produce nanofibers with uniform morphology. The prepared solution may electro spun using a stainless-steel needle with a gauge of 25, under a voltage of 15 kilovolts, and with a syringe advancement speed of two milliliters per hour. The distance between the needle and the collecting drum may be maintained at twenty centimeters, ensuring uniform deposition of nanofibers on the drum. The relative humidity may be controlled between 45 to 55 percent, and the temperature is maintained at 25 degrees Celsius to minimize defects and enhance fiber uniformity. The collected precursor nanofibers may be subjected to a heat treatment process to enhance their thermal stability and mechanical properties.

The heat treatment process may involve heating the precursor nanofibers at a controlled rate, first to 600 degrees Celsius at one degree per minute, and then to 700 degrees Celsius at five degrees per minute. The nanofibers may be held at 700 degrees Celsius for two hours to remove organic components and form thermally stable ceramic nanofibers. The nanofibers may then naturally be cooled to room temperature to prevent thermal shock and ensure structural integrity. The resulting nanofibrous membranes may exhibit low thermal conductivity and high tensile strength, making them suitable for a variety of thermal insulation applications.

The titanium-containing precursor may constitute 30 to 40 percent by weight of the total composition, ensuring thermal stability and mechanical performance. The silicon-containing precursor may constitute 15 to 20 percent by weight, enhancing the flexibility and insulation properties of the nanofibers.

The nanofibrous membranes produced using this composition demonstrate exceptional performance characteristics. The thermal conductivity of the membranes may be no more than 0.032 watts per meter-kelvin at room temperature, ensuring effective insulation. The tensile strength of the membranes may be at least 4 megapascals after heat treatment, enabling reliable performance in demanding applications. Such properties may make the composition 100 ideal for use in aerospace, electronics, and flexible insulation materials, addressing the need for high-performance thermal insulation solutions.

The synthesis of the titanium-containing precursor involves a molar ratio of 1:3:1 for tetra butyl titanate 104, galactic acetic acid 108, and acetylacetone 110. This ratio facilitates the formation 100 of polydiacetictitanium, which may be subsequently concentrated and re-dissolved in methanol to form a golden-red solution. This step may ensure homogeneity and enhances the compatibility of the precursor with other components in the composition. The titanium-containing and silicon-containing precursors may be combined in a molar ratio of 3:1, balancing thermal insulation and flexibility in the final product.

The composition 100 may ensure compatibility and interaction between the titanium-containing precursor, the silicon-containing precursor, the polymeric binder, and the solvent system. The specific ratios and processing conditions may be designed to produce nanofibers with consistent properties and high performance. The nanofibers may be versatile and adaptable, with applications ranging from high-temperature insulation materials to advanced aerospace components. The combination of low thermal conductivity, high tensile strength, and flexibility may make the composition 100 a significant advancement in the field of thermal insulation materials.

This disclosed invention addresses the limitations of existing insulation materials by providing a solution that combines superior thermal resistance, mechanical strength, and adaptability. The flexible ceramic nanofibers produced using this composition offer significant advantages in terms of performance and versatility. The use of advanced characterization techniques, including thermal conductivity measurements, tensile strength tests, and thermogravimetric analysis, validates the reliability and effectiveness of the nanofibers in various applications.

The disclosed invention represents a major improvement over existing technologies, offering a unique combination of properties that meet the demands of modern thermal insulation applications. The careful selection of materials and optimization of processing conditions ensure the scalability and reproducibility of the composition, making it suitable for industrial-scale production. The disclosed invention provides a reliable and efficient solution for addressing the growing demand for high-performance thermal insulation materials in a wide range of industries.

The development of flexible ceramic nanofibers for high-temperature thermal insulation involves a meticulous composition and processing method to achieve membranes with low thermal conductivity, excellent mechanical properties, and the ability to withstand temperatures up to 1200° C. The disclosed invention integrates carefully selected components that contribute to the uniformity, stability, and performance of the final nanofibrous membranes. The inclusion of a titanium-containing precursor enriched with reactive functional groups, such as terminal alkenes, facilitates radical polymerization and segment integration. This component plays a pivotal role in enhancing the thermal stability and mechanical properties of the membranes.

The silicon-containing precursor, which includes hydrolysable alkoxy groups, contributes to the thermal resistance and flexibility of the membranes. This precursor ensures that the membranes can maintain their structural integrity under high temperatures, making them suitable for applications in aerospace, electronics, and flexible insulation fields. The polymeric binder, selected from polyethylene oxide 106 with a molecular weight of approximately 1,000,000, provides spinnability and structural uniformity during the electrospinning process. The binder ensures that the fibers maintain consistent morphology and distribution, which is critical for achieving the desired performance characteristics.

The synthesis of the titanium-containing precursor may involve a reaction between tetra butyl titanate (TBOT) 104, galactic acetic acid 108, and acetylacetone 110 in a molar ratio of 1:3:1. This reaction may be conducted under controlled conditions, including an ice bath, to ensure the formation of polydiacetictitanium (PDET). The PDET may then age to reinforce the gel network, improving its stability and performance during subsequent processing steps. The aged precursor may be dissolved in an alcohol-based solvent system comprising anhydrous methanol 112 and glacial acetic acid 108. This solvent system promotes solubility and homogeneity, ensuring that all components may be uniformly mixed.

The addition of the silicon-containing precursor to the titanium-containing precursor solution may create a hybrid TiO2/SiO2 solution. The integration of these precursors in a molar ratio of 3:1 balances the thermal insulation and flexibility of the resulting nanofibrous membranes. The solution is further homogenized with the addition of polyethylene oxide 106 and stirred to ensure complete dissolution. This step is crucial for producing defect-free nanofibers with consistent thermal conductivity and tensile strength.

Characterization of the nanofibrous membranes may involves several key tests to validate their performance. The thermal conductivity may be measured using the transient hot wire technique, confirming that the membranes exhibit a thermal conductivity of no more than 0.032 W/m at room temperature. Tensile strength tests may be conducted using a T150 UTM monofilament tensile testing machine, revealing a tensile strength of at least 4 MPa after heat treatment. Such results demonstrate the membranes' suitability for high-performance thermal insulation applications.

The thermogravimetric analysis provides insights into the mass loss of the membranes when heated to 1200° C. This test confirms the thermal stability of the membranes and their ability to retain structural integrity at high temperatures. The membranes are also subjected to heating tests in a ceramic furnace at 1200° C. for 4 hours, which further validates their thermal resistance. These tests highlight the membranes' adaptability for use in extreme environments, such as aerospace and electronics.

The solvent system, comprising anhydrous methanol 112 and glacial acetic acid 108 in a volume ratio of 4:1, optimizes the dissolution of the precursors and prevents premature gelation. This ensures that the components remain homogenous throughout the electrospinning process. The use of polyethylene oxide 106 as a polymeric binder enhances the spinnability of the composition 100, allowing for the production of uniform nanofibers. The binder also contributes to the flexibility of the membranes, making them suitable for applications requiring adaptable insulation materials.

The hybrid TiO2/SiO2 nanofibrous membranes exhibit unique properties that set them apart from existing insulation materials. Their low thermal conductivity ensures effective insulation, while their high tensile strength allows them to withstand mechanical stresses. These properties make the membranes ideal for use in industries requiring high-performance thermal insulation materials. The flexibility of the membranes further enhances their applicability, allowing them to be used in applications where rigid materials would fail to perform effectively.

In addition to their thermal and mechanical properties, the nanofibrous membranes demonstrate excellent adaptability for various applications. Their ability to maintain structural integrity at high temperatures and under mechanical stress makes them suitable for use in aerospace, electronics, and other demanding environments. The membranes' unique combination of properties ensures that they can meet the requirements of modern insulation applications, providing a reliable and effective solution for high-temperature environments.

The composition incorporates carefully balanced molar ratios for each precursor to optimize the properties of the resulting nanofibrous membranes. The titanium-containing precursor, enriched with reactive functional groups, interacts effectively with the silicon-containing precursor to form a stable hybrid network. This interaction ensures that the nanofibers exhibit a uniform distribution of thermal and mechanical properties across their structure. The polymeric binder plays a critical role in maintaining the uniformity and integrity of the fibers during the electrospinning process, ensuring that the nanofibers maintain consistent morphology and performance characteristics.

In a case that no conflict occurs, the embodiments in the present disclosure and the features in the embodiments may be mutually combined. The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed for:

1. A composition of flexible ceramic nanofibers for thermal insulation applications, the composition comprising:
tetraethyl orthosilicate (TEOS) as a silica precursor;
tetra butyl titanate (TBOT) as a titanium precursor;
polyethylene oxide (PEO) as a porogen;
glacial acetic acid as a catalyst for hydrolysis and condensation reactions; and
acetylacetone as a chelating agent for precursor stabilization.

2. The composition of claim 1, wherein the composition comprising:
a 208.33 Mw of tetraethyl orthosilicate (TEOS);
a 340.32 Mw of tetra butyl titanate (TBOT);
a 1,000,000 Mw of polyethylene oxide (PEO);
a 60 Mw of glacial acetic acid; and
a 100 Mw of acetylacetone.

3. The composition of claim 1, wherein the composition also comprises anhydrous methanol (CH3OH).

4. The composition of claim 3, wherein the composition also comprises a 32 Mw of anhydrous methanol (CH3OH).

5. The composition of claim 1, wherein the composition also comprises deionized water.

6. The composition of claim 5, wherein the composition also comprises an 18 Mw of deionized water.

7. A method for preparation of flexible ceramic nanofibers for thermal insulation applications, the method comprising:
preparing a titanium precursor solution by dissolving tetra butyl titanate (TBOT) in anhydrous methanol;
adding glacial acetic acid in a particular ratio to tetra butyl titanate (TBOT) while stirring;
adding acetylacetone in a particular ratio to tetra butyl titanate (TBOT) and stirring vigorously;
preparing a silica precursor solution by dissolving tetraethyl orthosilicate (TEOS) in anhydrous methanol in a particular ratio;
adding polyethylene oxide (PEO) and heating mixture;
mixing the titanium precursor solution and silica precursor solutions and constantly stirring to form a TiO₂/SiO₂ electrospinning precursor solution;
electrospinning the precursor solution to form nanofibrous membranes under the pre-determined conditions; and
sintering the nanofibrous membranes to obtain porous ceramic nanofiber membranes.

8. The method of claim 7, wherein the glacial acetic acid is added in a molar ratio of 3:1 to tetra butyl titanate (TBOT).

9. The method of claim 7, wherein the acetylacetone is added in a 1:1 molar ratio to tetra butyl titanate (TBOT).

10. The method of claim 7, wherein the tetraethyl orthosilicate (TEOS) is dissolved in anhydrous methanol in a molar ratio of 0.2 relative to tetra butyl titanate (TBOT).

11. The method of claim 8, wherein a 3% v/v of glacial acetic acid is added to the tetraethyl orthosilicate (TEOS) dissolved in anhydrous methanol.

12. The method of claim 7, wherein the polyethylene oxide (PEO) at 1% w/v concentration is added to tetraethyl orthosilicate (TEOS).

13. The method of claim 7, wherein the TiO₂/SiO₂ electrospinning precursor solution have viscosity between 500 and 2000 cp.

14. The method of claim 7, wherein the process of sintering further includes:
heating to 600° C. at a rate of 1° C./min;
maintaining the membranes at 600° C. for 2 hours; and
cooling to room temperature to obtain porous ceramic nanofiber membranes.

15. The method of claim 7, wherein the electrospinning of the precursor solution is performed at ambient temperature of approximately 25° C.

16. The method of claim 7, wherein the electrospinning of the precursor solution is performed at relative humidity of 45%-55%.

17. The method of claim 7, wherein the electrospinning of the precursor solution is performed at spinning voltage of 15 kV.

18. The method of claim 7, wherein the electrospinning of the precursor solution is performed using needle gauge of 25G and syringe advancement rate of 2 mL/h, with a 20 cm distance between needle and collector.

19. The method of claim 7, wherein the electro-spined precursor solution is collected by a roller receiver.

20. The method of claim 7, wherein the method also includes performing calcination to decompose polyethylene oxide (PEO) in the final ceramic structure.
